(19) United States
(12) Patent Application Publication
(10) Pub. No.: US 2012/0070807 A1
(43) Pub. Date: Mar. 22, 2012

(54) Accelerated language acquisition accelerated ability acquisition

(76) Inventor: Jeffrey Pickett Prather, Dallas, TX (US)

(21) Appl. No.: 12/803,629

(22) Filed: Jun. 30, 2010

(51) Int. Cl. G09B 19/06

(52) U.S. Cl. 434/157; 434/156

(57) ABSTRACT

An improved method for increasing listening comprehension in one's own or a foreign language, and hence, conversational ability. This method improves learners' listening comprehension by starting them at speeds at which they can successfully process auditory data. Then processing ability is improved by increasing flow rate and phonemic discrimination.

### RELATED APPLICATIONS

Claiming priority date of Jun. 30, 2009 for application filed by Jeffrey Pickett Prather, the first sentence of which was “What is claimed is: A method to rapidly increase students' listening comprehension of a target language . . . . ”

### FEDERALLY SPONSORED RESEARCH

none

Field: This application relates to language acquisition, specifically to an improved method to increase listening comprehension and conversation in the target language.

### SUMMARY

I have found that this method improves students' listening comprehension faster than traditional methods. In test groups, students have increased on average their Listening Ability Levels two percent per session, allowing them to double their ability in six weeks. Nothing like this exists anywhere else. Companies will save millions of dollars in lost time training their executives. Academics will be able to much more rapidly participate n collegial exchanges with their foreign counterparts.

These results are possible because I address the cause of the listening comprehension problem and hence, the conversation problem. Many speakers are able to produce grammatical, intelligible utterances in the target language. The reason they cannot converse is that they cannot fully understand their partner in the conversation. This method in its various embodiments solves that problem.

### SPECIFICATION

In the first embodiment students:

1. Determine their Listening Ability Levels (LAL) (This is a playback or reproduction speed.)

2. Are grouped according to their Listening Ability Levels if there is more than one student

3. Read and discuss the possible answers to a prompt, thus establishing a context

4. Listen to a recording of a prompt played at their LAL

5. Transcribe what they have heard literally or phonetically (only the prompt is transcribed) (A list of phonetic symbols from an appropriate phonetic alphabet may be used such as but not limited to the International Phonetic Alphabet)

6. Have the correct aspects of their transcription brought to their attention by a teacher

7. Listen, transcribe and have their transcriptions marked again, and again until they produce a correct transcription. (A list of phonetic symbols may be provided to help in this activity. Also, the teacher may assist the students after the latter have tried unsuccessfully a plurality of times. Finally, the teacher may “give” or reveal to the students a small segment of the transcription if the students have failed in a vast plurality of attempts and especially if the particular phoneme does not exist as a natural part of the students' native language. While numerous examples from various languages could be cited, one would be the voiced “th” sound of English, as in the word “The” for a Japanese person.

Note: After a plurality of attempts, the teacher should repeat only the section of the language example that the students are having trouble with. This is easily done with the looping function readily available on many audio players, such as but in no way limited to the Denon Dn-SI000 or the Tascam DR-07 or the computer based Total Recorder Professional edition. Through the “looping” capability, an audio player can easily be instructed to play back a particular segment of a prompt. These players can also change the speed of the play back without changing the pitch. If more than one section of the prompt is problematic, the teacher may choose whichever he or she would like to begin with. In this embodiment the teacher would start with that section which he or she believed would be easiest for the student.

8. Then answer the question associated with the prompt

9. Have the answer graded

10. Advance to the next question and repeat steps 3-9.

11. End the session. (This may occur after only a few questions, after one, two or three questions have been answered.) The important thing is not the quantity of questions answers, but the quality of the students' transcriptions of the prompts.

12. Break from the Accelerated Language Acquisition process, and listen to 20 to 80 minutes of audio material reproduced at or near their LAL

13. At the next lesson, increase the rate (velocity) of reproduction of the new prompts by a few percentage points, two percentage points, in this embodiment.

14. Repeat Steps 3-13 until the mastery objective is reached

Students are tested and their Listening Ability Levels (LAL) are determined. (Throughout this description “students” will be used. It should be understood that the singular may also be inferred. “Students” is employed to maintain gender neutrality.) The Listening Ability Level (LAL) is a unique and valuable addition to the field of language acquisition, because it separates two different skills. LAL refers only to students' ability to discern individual phonemes in words spoken at a particular speed, an auditory coding skill, as opposed to the skill usually tested under listening comprehension, i.e., the ability to hear a prompt and infer the meaning well enough to answer multiple choice questions correctly. If students can discern individual phonemes, they can store and then recall what is actually said in some kind of auditory event, such as but not limited to conversations in which they are involved, lectures, TV and radio programs, sermons, etc. Thus, they can participate in training, entertainment, and conversations of all types. Being able to do so will give them heightened motivation, the kind of motivation that can only be had through being intimately involved in an activity that is genuinely interesting.

### Determining the Listening Ability Level

The LAL is determined by playing a recording of a sentence of a plurality of syllables spoken at a normal rate from a recording a plurality of times. Immediately after each time the sentence is played, students are given the opportunity to write down what they just heard. Each opportunity lasts 30 seconds (more or less time in other embodiments). Also, other embodiments my employ other speech units and units of other lengths.

For example: Students hear “Bob was getting on the bus.”

During the first 30 second response time they may write “ba zabas.”

On the second iteration they may write “bab wz ding on zabas.”

On the third iteration they may fill in even more and/or correct themselves, yielding, “Bob was gedding on zabas.” Notice that the third attempt includes a mixture of literal and phonetic transcription. “Bob” is an example of a literal transcription of the auditory data they heard; i.e., while “Bob” sounds like “bab”, the students recognized that what they were hearing was “Bob” and wrote the word as it is ordinarily spelled. On the other hand, “zabas” for “the bus” is a phonetic transcription. Clearly they did not recognize the words the speaker in the recording was saying, but they did their best to capture the sounds phonetically.

So how would the tester grade the final attempt “Bob was gedding on zabas”? In this embodiment the score would be six out of seven or 86% because every phoneme was accounted for except for the “th” in “the.”

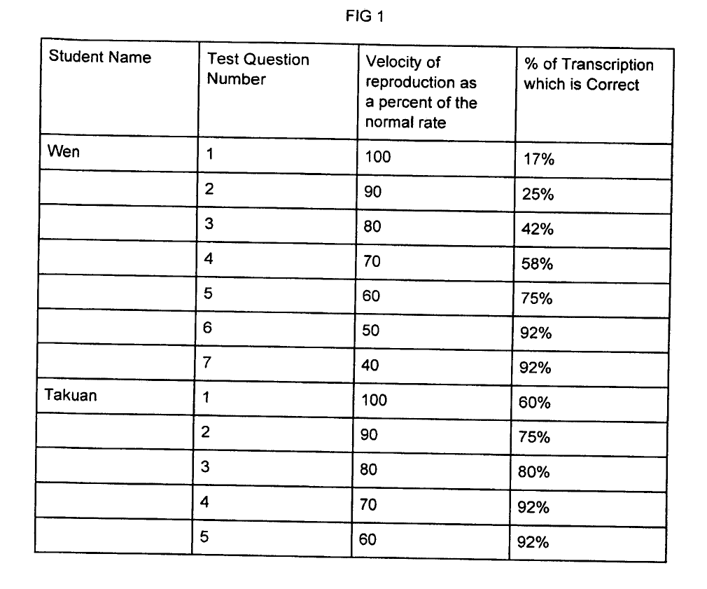

The above process is repeated with new sentences, each iteration with a new sentence. The first is played at 100% of the normal speaking rate, the second at 90%, the third at 80%, and so on down by 10 percentage points each time down to 40%. Other embodiments could increment the velocity by different amounts. FIG. 1 When the students can transcribe 90% of the sentence, the identifying rate at which they can do so is called their Listening Ability Level.

In FIG. 1, Wen's LAL, Listening Ability Level, would be 50% as she achieved over 90% accuracy in transcribing the sentence when the audio was reproduced at a velocity of 50% of normal. Takuan's LAL would be 70% because he transcribed the sentence with over 90% accuracy when it was slowed down to 70% of normal velocity.

### SECOND EMBODIMENT AND OPERATION

The “teacher” may be anyone trained in the method, including but not limited to another student, a teacher's aide, a spouse, or parent, etc. Also, the one acting as the teacher may point out the incorrect portions of the students' transcriptions. As regards the repeated play back of a troublesome part of a prompt, the teacher may also begin with the most difficult part, or, alternatively, a moderately difficult part. The pitch of the reproduced audio may also be changed. At step 12, the number of percentage points the velocity of the player is increased may be more or less than 2%. It may be zero, or in the case of a long break between lessons, it may be negative. The answers as well as the prompt may be transcribed if they are produced in an auditory format. If they are written, the students may be asked to read them aloud.

### THIRD EMBODIMENT AND OPERATION

A computer may guide the students through the method reflected in the First Embodiment, adjusting the velocity of reproduction, and assessing the students transcriptions and grading their responses.

### ADVANTAGES

I have found that this method improves students' listening comprehension faster than traditional methods. In test groups, students have increased on average their Listening Ability Levels two percent per session, allowing them to double their ability in six weeks. Nothing like this exists anywhere else. Companies will save millions of dollars in lost time training their executives. Academics will be able to much more rapidly participate in collegial exchanges with their foreign counterparts.

These results are possible because I address the cause of the listening comprehension problem and hence, the conversation problem. Many speakers are able to produce grammatical, intelligible utterances in the target language. The reason they cannot converse is that they cannot fully understand their partner in the conversation. This method in its various embodiments solves that problem.

### CONCLUSION, RAMIFICATIONS, AND SCOPE

Much of the problem of listening comprehension results from simply not knowing what is being said. Other methods have attempted to get students to infer the meaning from contextual clues. This application describes a method which addresses the heart of the listening comprehension problem, the intake, discrimination and identification of audio data. It improves the rate at which listeners can process speech.

I claim:

1. A method for teaching a subject (such as, but not limited to a foreign language) which involves determining the fastest velocity at which a student(s) can accurately discriminate between distinct bits of meaning, such as but not limited to phonemes, and gradually increasing their processing rate through exposing them to the target material at progressively faster and faster velocities as they demonstrate mastery at the preceding slower rate.

2. A method for improving listening comprehension by having the student(s) identify the distinct phonemic components of language examples in the target language (their own or foreign), the identification consisting of transcribing the language passage literally or phonetically while the passage is played at a velocity at which the students can be successful; this velocity is gradually increased until the students have met their objectives.
